(19) United States
(12) Patent Application Publication
(10) Pub. No.: US 2008/0115396 A1
(43) Pub. Date: May 22, 2008

(54) PROTECTIVE PAPER HOLDER

(76) Inventor: Ricardo Gamboa, Monterey Park, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/943,132

(22) Filed: Nov. 20, 2007

Related U.S. Application Data
(60) Provisional application No. 60/866,460, filed on Nov. 20, 2006.

(51) Int. Cl. G09F 3/18

(52) U.S. Cl. 40/661

(57) ABSTRACT

The protective paper holder has a pair of adjacent, planar, generally transparent and waterproof sheets sealed to one another about a portion of their periphery to form an interior, paper-sheet receiving compartment and an access opening for the paper-sheet receiving compartment. A sealing means associated with the access opening selectively seals the access opening from the surrounding environment. Preferably, this sealing means forms a watertight seal via a zip-lock seal, a set of tongue-in-groove fasteners, a zipper, or a set of hook and loop fasteners.

### BACKGROUND OF THE INVENTION

The present invention is generally directed to a device for holding media. More particularly, the present invention is directed to a protective paper holder capable of protecting media sheets from adverse environmental conditions.

Protection and transportation of media is important as exposure to the environment and direct handling can result in physical damage to the media. For example, media such as photographs or paper having indicia printed thereon are vulnerable to ambient humidity and other moisture, such as rain, especially when exposed to the environment in an unprotected state. The photograph or printed paper may also be accidentally damaged, crumpled or otherwise wrinkled during handling. In response, sheet protectors have been devised to protect photographs, printed material and the like. A conventional protective device, such as the one described in U.S. Pat. No. 3,670,434, generally includes a cover sheet of transparent material disposed over an opaque backing sheet with several circular perforations for retention in a corresponding loose-leaf binder.

Conventional protective devices, such as the one described in the '434 patent, have certain disadvantages. For example, the protective device must be constantly carried by hand or in a bulky, heavy loose-leaf binder. Other protective devices may endeavor to protect the media from directly contacting the environment. But, moisture may still access the media if no environmental seal between the media and the environment is provided. Another disadvantage of conventional protective devices is the inability to protect and display multiple media objects within the same device.

Several patents have endeavored to improve on these conventional protective devices. For example, U.S. Pat. No. 4,810,544 discloses a transparent sleeve for protecting printed media. The sleeve is still either carried by hand or requires placement in a loose-leaf binder. U.S. Pat. No. 5,335,027 discloses a transparency folder having an opaque backing sheet that prevents at least one side of the media stored therein from being visible. Like the device in the '544 patent, this folder must still be carried by hand or in a loose-leaf binder. Alternatively, U.S. Pat. No. 5,795,089 discloses a transparency sheet protector that also incorporates an opaque backing sheet that prevents at least one side of the media stored therein from being visible. Like the devices in the '544 and '089 patents, the sheet protector must be carried by hand or in a loose-leaf binder. Lastly, U.S. Pat. No. 6,019,539 discloses a flexible sheet protector that must also be carried by hand or in a loose-leaf binder.

Accordingly, there is a need for a protective paper holder that improves on conventional sheet protectors that otherwise must be held or stored in a loose-leaf binder at all times. Such a protective paper holder should provide visibility to all sides of the media held therein, provide an environmental seal, provide a convenient and quick manner of opening the holder, provide a mechanism for carrying the protective paper holder hands free, and provide a simple design that is economical to manufacture. The present invention fulfills these needs and provides other related advantages.

### SUMMARY OF THE INVENTION

The present invention is for a protective paper holder having a pair of adjacent, planar, generally transparent and waterproof sheets sealed to one another about a portion of their periphery. The sheets form an interior, paper-sheet receiving compartment that is accessible via an opening formed therein. A sealing means selectively seals the access opening from the surrounding environment. Preferably, the sealing means forms a watertight seal using a zip-lock seal, a set of tongue-in-groove fasteners, a zipper, or a set of hook and loop fasteners.

The protective paper holder of the present invention further includes a strap for releasably attaching the protective paper holder to a person or an object. The strap is preferably adjustable and includes a fastener configured for attachment to an extender for expanding the size of the strap. The strap may further include a swivel for rotationally mounting the sheets to the strap. The strap may attach to an aperture formed around the periphery of the sheets. Alternatively, the periphery may include a plurality of apertures for holding the protective paper holder in a ring binder. Furthermore, the present invention may include a grommet for structurally reinforcing the aperture or apertures.

In another embodiment, the protective paper holder of the present invention includes a second pair of adjacent, planar, generally transparent waterproof sheets sealed to one another about a portion of their periphery to form a second interior, paper-sheet receiving compartment and a second access opening for the paper-sheet receiving compartment, wherein the second pair of sheets are connected to the first pair of sheets about a spline. The first and second pair of sheets are rotatable about a fold formed in the spline. The first and second sheets may be secured to one another in a closed configuration with a fastener that comprises VELCRO, a button, a snap, or a magnet.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is frontal perspective view of a protective paper holder embodying the present invention, illustrating connection to a neck cord;

FIG. 2 is frontal perspective view of the protective paper holder of FIG. 1, illustrating connection to a belt cord;

FIG. 3 is a perspective view of the protective paper holder of FIG. 1, illustrating a user holding the protective paper holder in a closed configuration;

FIG. 4 is a perspective view of the protective paper holder of FIG. 1, illustrating a user holding the protective paper holder in an open configuration;

FIG. 5 is a top view of a protective paper holder of the present invention, in a closed configuration;

FIG. 6 is a top view of the protective paper holder of FIG. 5, in an open configuration;

FIG. 7 is a top view of the protective paper holder of FIG. 6, illustrating insertion of a sheet into a sealable protective sleeve; and

FIG. 8 is a top view of an alternative protective paper holder of the present invention, in a closed configuration.

### DETAILED DESCRIPTION OF THE PREFERRED EMBODIMENTS

As shown in the representative figures for purpose of illustration, the present invention resides in a protective paper holder that includes a mechanism for being carried by means other than by hand or a loose-leaf binder. The protective paper holder of the present invention also provides increased visibility to all sides of the media held therein.

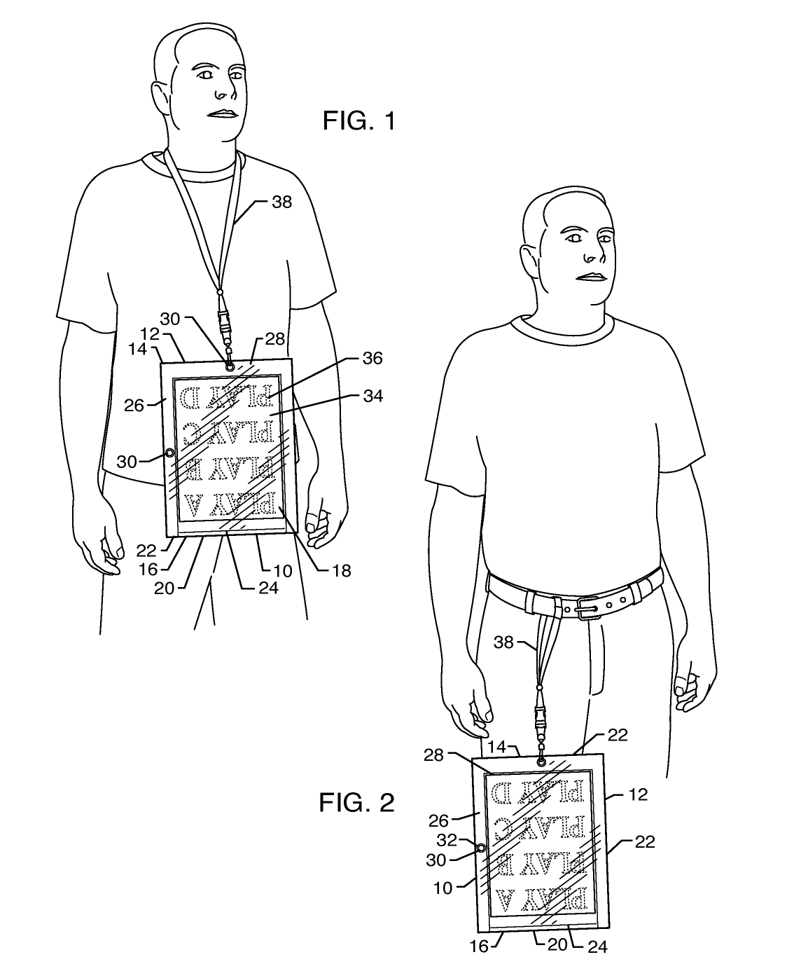

With reference to FIG. 1, a protective paper holder 10 includes a body 12 formed by a first and second relatively thin, flexible sheets 14, 16 that define at least one retaining pocket 18 therebetween. An opening 20 to the retaining pocket 18 is positioned along any of the edges 22 (FIG. 2) of the protective paper holder 10. The remaining edges 22 are accordingly closed. The sheets 14, 16 may be joined together using various methods known in the art that include, but are not limited to, heat sealing, mechanical fasteners or the like. The opening 20 is sealed from the environment using a sealing mechanism 24, such as a zip-lock seal, tongue in groove fasteners, zipper, hook and loop fasteners or the like. Alternatively, the body 12 includes a flap (not shown) positioned over the opening 20. Fasteners may be used to secure the flap to the body 12.

A pair of borders 26, 28 are disposed between the retaining pocket 18 and the closed edges 22 of the protective paper holder 10. The borders 26, 28 each include at least one bore 30 (FIG. 1). A grommet 32 is inserted into the bore 30 for structural reinforcement. The grommet 32 may be made of various materials including, but not limited to, metal, plastic or the like.

The first and second sheets 14, 16 are preferably formed from a transparent material sturdy enough to protect various objects placed within the retaining pocket 18. Preferable objects include, but are not limited to, sheets of printed material, photographs, photographic negatives, postcards, awards, coupons or certificates. FIGS. 1 -4 and 7 show at least one sheet of printed media 34 having an indicia 36 printed thereon and held within the pocket 18. The protective paper holder 10 and the pocket 18 may be sized and shaped as needed to retain various pieces of paper 34 that include 8.5 inch by 11 inch paper, A4 paper, legal size paper sheets or the like.

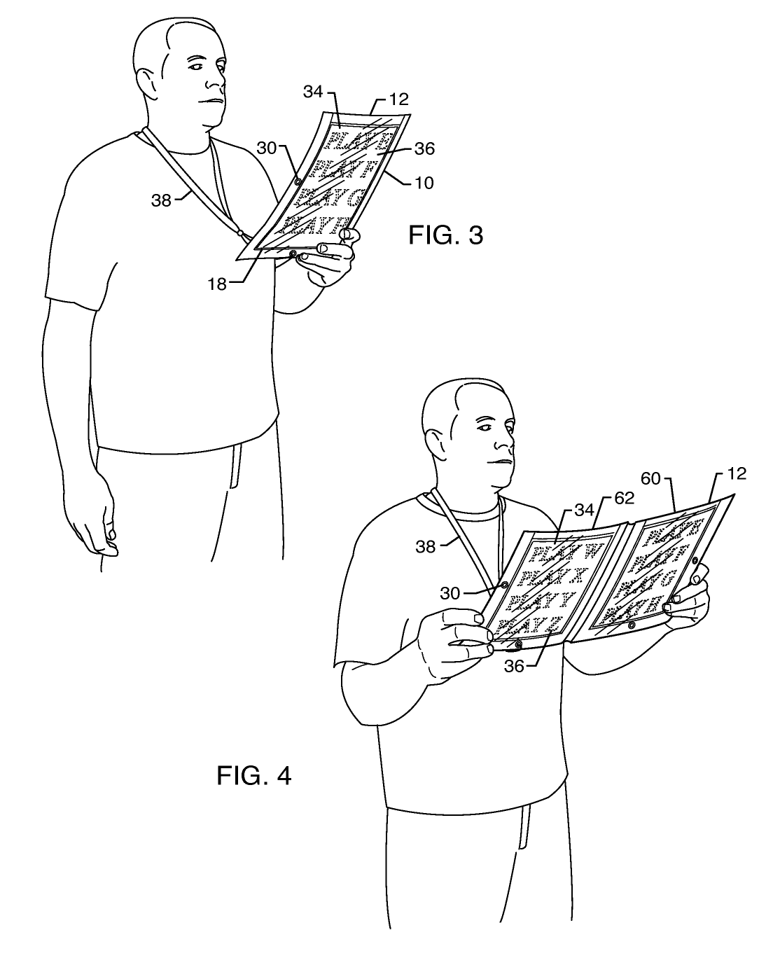

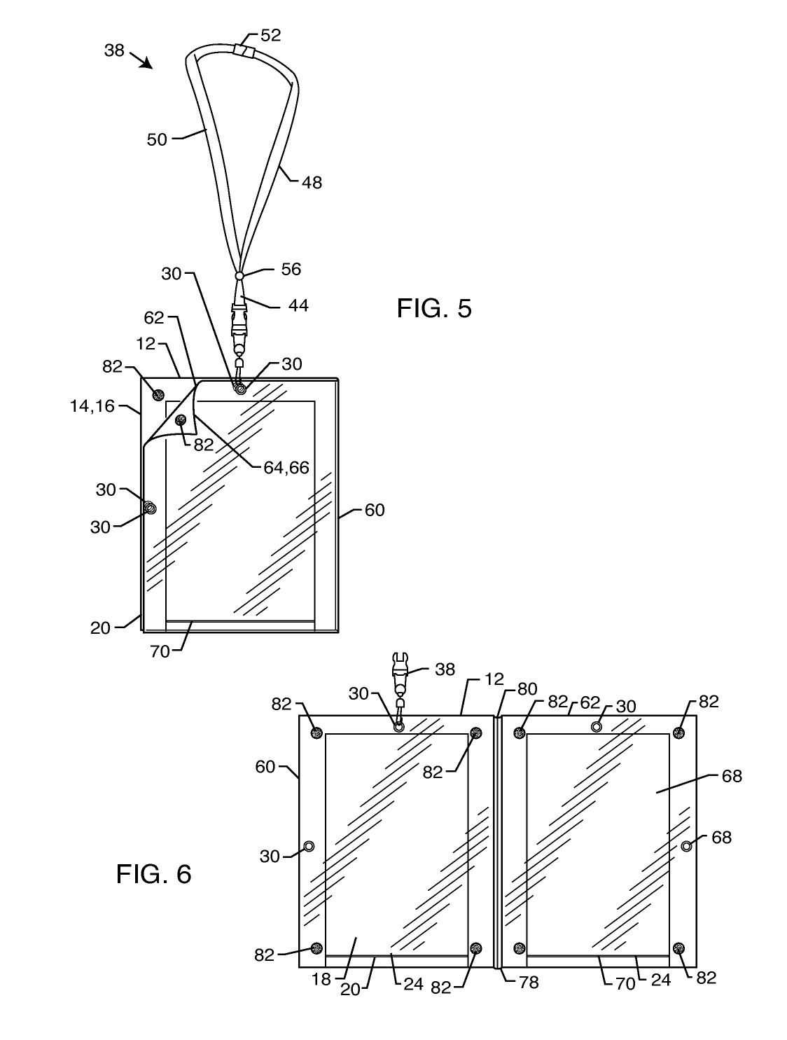

A strap assembly 38 may be attached to one of the bores 30 to enable a user to carry the protective paper holder 10 hands free as generally shown in FIG. 2. The strap assembly 38 may also retain the protective paper holder 10 about the neck, wrist, belt or the like, without danger of the protective paper holder 10 falling to the ground when released. The strap assembly 38 may be a strap and corresponding buckle, multiple straps, multiple buckles or other similar retainer mechanisms. As best shown in FIG. 8, the strap assembly 38 includes a fastener 40, such as a snap hook, for engaging the bore 30. The snap fastener 40 is itself pivotally connected to one half of a buckle fastener 42 while the other half of the buckle fastener 42 is connected to a strap 44. The buckle fastener 42 is preferably a side release buckle while the strap 44 may include a strap, lanyard, cord or the like. The strap 44 extends through an eyelet 46 of the buckle fastener 42. Opposite ends 48, 50 of the strap 44 are joined by another buckle fastener 52 to form a loop 54, best shown in FIG. 5. Preferably, the buckle fastener 52 is a side release buckle or a detent release buckle. The size of the loop 54 is adjustable by a slide 56 running along the length of the strap 44. The ends 48, 50 of the strap 44 pass through a bore (not shown) in the slide 56 before the ends 48, 50 are joined by the buckle 52 to form the loop 54. The loop 54 is adjustable to fit around a body part such as a wrist or a neck (illustrated in FIGS. 1, 3 and 4) or for attachment to a garment, such as a belt (FIG. 2). For example, the buckle fastener 52 secures the protective paper holder 10 to a belt by adjusting the size of the loop 54. The strap assembly 38 may include additional extender straps 58 (FIG. 8) to expand the largest adjustable size of the loop 54. FIG. 8 illustrates two of the extender straps 58 interconnected within the loop 54 of the strap 44. The buckle fasteners 52 in the strap 44 and the buckle fasteners 52 in the extender straps 58 are compatible for easy interchangeability.

FIGS. 4-7 illustrate an additional protective paper holder 60, including the previously described features of the protective paper holder 10. The protective paper holder 60 has a body 62 formed by a third and fourth sheets 64, 66 that define at least one retaining pocket 68 therebetween. An opening 70 to the retaining pocket 68 is positioned along at least one edge 72 of the protective paper holder 60 with the remaining edges 72 being closed. The sheets 64, 66 may be joined together using various methods known in the art that include, but are not limited to, heat sealing, mechanical fasteners or the like. The opening 70 is likewise sealed from the environment using the sealing mechanism 24. A pair of borders 74, 76 are disposed between the retaining pocket 68 and the closed edges 72 of the protective paper holder 10. The borders 74, 76 each include at least one bore 30. The grommet 32 is inserted into the bore 30 for structural reinforcement.

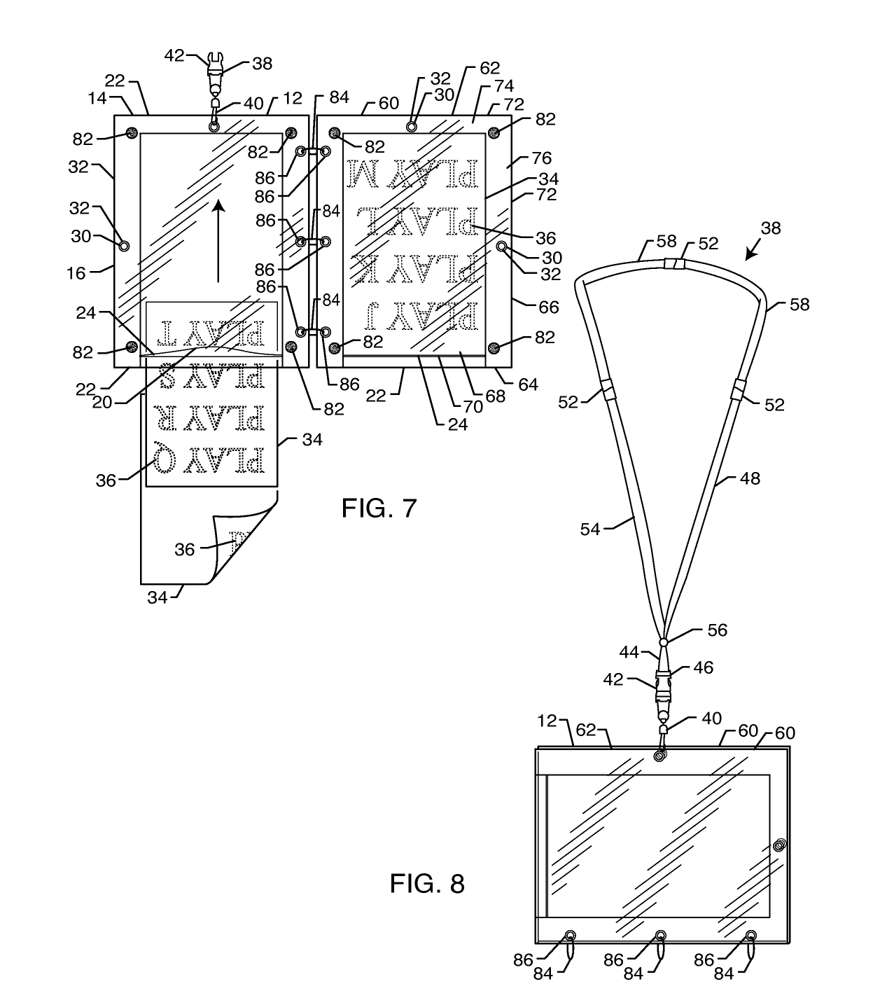

The third and fourth sheets 64, 66 are formed from the same or similar material as the first and second sheets 14,16. The bodies 12, 62 are joined by a binding spine 78 having a fold 80 along which the bodies 12, 62 may fold toward one another in book-fashion. The fasteners 82 are positioned around the edges 22, 72 to secure the protective paper holder 60 in a closed book configuration. Preferably, the fasteners 82 are positioned generally near the corners of the bodies 12, 62. The fasteners 82 may include hook and loop fasteners, snap fasteners, male/female fasteners, VELCRO, or the like. Alternatively, the first and second sheets 12,14 may be held together in the open book configuration by a series of connectors 84 placed through a series of corresponding binder bores 86 illustrated in FIGS. 7 and 8. In this configuration, the first and second sheets 12, 14 may be used like a flip chart. The connectors 84 may be any suitable connector or clamp known in the art to retain multi-page documents, including binder rings that manually open and close.

The strap assembly 38 may be secured to the protective paper holder 60 through a single bore 30 in one of the bodies 12, 62 to facilitate movement of the protective paper holder 60 between open and closed book configurations, as illustrated in FIGS. 5 and 6, respectively. Alternatively, the protective paper holder 60 may be aligned through the bores 30 of the bodies 12, 62, to keep the protective paper holder 60 secured in a closed book configuration. FIG. 7 illustrates at least one sheet of paper 30 held within the pocket 18 of the body 12 while two sheets of paper 30 are inserted, back-to-back, into the pocket 68 of the body 62.

The transparent material forming the sheets 14, 16, 64, 66 may be formed from materials that include, but not limited to, organic materials, synthetic materials, plastics, polypropylenes, acetates, diacetates or the like. The material may be non-stick or include a sticky layer of light adhesive. Alternatively, one ore more of the sheets 14, 16, 64, 66 may be opaque, translucent, colored or non-colored.

Alternatively, one or more of the border sections 22, 24, 64, 66 may include at least two bores to facilitate insertion of the protective paper holder 10, 60 into a loose-leaf binder. A washable marker can be used to write on top of the sheets 14, 16, 64, 66 since the indicia 36 on the paper 34 is visible through the sheets 14, 16, 64, 66. This allows a user to repeatedly reuse the same worksheet paper 34. In an alternative embodiment, one of the respective sheets 16, 66 of each body 12, 62 may be a relatively thick, hard sheet to which the soft, flexible sheet 14, 64 is connected to form the pockets 18, 68 of the body 12, 62.

All features of the various embodiments discussed above can be mixed and matched to define an embodiment that is not directly illustrated in the accompanying figures.

Although several embodiments have been described in detail for purposes of illustration, various modifications may be made to each without departing from the scope and spirit of the invention. Accordingly, the invention is not to be limited, except as by the appended claims.

What is claimed is:

1. A protective paper holder, comprising:
a pair of adjacent, planar, generally transparent and waterproof sheets sealed to one another about a portion of their periphery to form an interior, paper-sheet receiving compartment and an access opening for the paper-sheet receiving compartment;
means associated with the access opening for selectively sealing the access opening shut; and
a strap for releasably attaching the protective paper holder to a person or object.

2. The paper holder of claim 1, wherein the sealing means forms a water-tight seal.

3. The paper holder of claim 1, wherein the sealing means comprises a Zip-lock seal, a set of tongue-in-groove fasteners, a zipper, or a set of hook and loop fasteners.

4. The paper holder of claim 1, wherein the strap is adjustable and includes a fastener.

5. The paper holder of claim 4, including an extender configured for attachment to the fastener, thereby expanding the size of the strap.

6. The paper holder of claim 1, wherein the strap includes a swivel.

7. The paper holder of claim 1, wherein the periphery of the paper holder includes an aperture.

8. The paper holder of claim 7, including a plurality of said apertures for storage of the paper holder in a ring binder.

9. The paper holder of claim 1, including a second pair of adjacent, planar, generally transparent and waterproof sheets sealed to one another about a portion of their periphery to form a second interior, paper-sheet receiving compartment and a second access opening for the paper-sheet receiving compartment, the second pair of sheets being connected to the first pair of sheets about a spline.

10. The paper holder of claim 9, wherein the first and second pair of sheets rotate about a fold formed in the spline.

11. The paper holder of claim 9, wherein the first and second pair of sheets are secured to one another in a closed configuration with a fastener.

12. The paper holder of claim 11, wherein the fastener includes Velcro, a button, a snap, or a magnet.

13. The paper holder of claim 1, including a grommet for structurally reinforcing the aperture.

14. A protective paper holder, comprising:
a pair of adjacent, planar, generally transparent and waterproof sheets sealed to one another about a portion of their periphery to form an interior, paper-sheet receiving compartment and an access opening for the paper-sheet receiving compartment;
means associated with the access opening for selectively forming a water-tight seal across the access opening, wherein the sealing means comprises a Zip-lock seal, a set of tongue-in-groove fasteners, a zipper, or a set of hook and loop fasteners;
an adjustable strap having a fastener for releasably attaching the protective paper holder to a person or object; and
an extender configured for attachment to the fastener, thereby expanding the size of the strap.

15. The paper holder of claim 14, wherein the strap includes a swivel.

16. The paper holder of claim 14, wherein the periphery of the paper holder includes an aperture or a plurality of said apertures for storage of the paper holder in a ring binder.

17. The paper holder of claim 14, including a second pair of adjacent, planar, generally transparent and waterproof sheets sealed to one another about a portion of their periphery to form a second interior, paper-sheet receiving compartment and a second access opening for the paper-sheet receiving compartment, the second pair of sheets being connected to the first pair of sheets about a spline.

18. The paper holder of claim 17, wherein the first and second pair of sheets rotate about a fold formed in the spline and are secured to one another in a closed configuration with a fastener.

19. The paper holder of claim 18, wherein the fastener includes Velcro, a button, a snap, or a magnet.

20. A protective paper holder, comprising:
a pair of adjacent, planar, generally transparent and waterproof sheets sealed to one another about a portion of their periphery to form an interior, paper-sheet receiving compartment and an access opening for the paper-sheet receiving compartment;
means associated with the access opening for selectively forming a water-tight seal across the access opening, wherein the sealing means comprises a Zip-lock seal, a set of tongue-in-groove fasteners, a zipper, or a set of hook and loop fasteners;
a strap for releasably attaching the protective paper holder to a person or object; and
a second pair of adjacent, planar, generally transparent and waterproof sheets sealed to one another about a portion of their periphery to form a second interior, paper-sheet receiving compartment and a second access opening for the paper-sheet receiving compartment, the second pair of sheets being connected to the first pair of sheets about a spline, wherein the first and second pair of sheets rotate about a fold formed in the spline and are secured to one another in a closed configuration with a fastener comprising Velcro, a button, a snap, or a magnet.
